(19) United States
(12) Patent Application Publication
(10) Pub. No.: US 2022/0417195 A1
(43) Pub. Date: Dec. 29, 2022

(54) METHODS AND SYSTEMS FOR ALLOWING A USER TO MANAGE EMAIL MESSAGES

(71) Applicant: XEROX CORPORATION, Norwalk, CT (US)

(72) Inventors: Shanmukha Teja Badana, Amadalavalasa Mandal (IN); Pedireddey Devi, Kirlampudi (IN)

(73) Assignee: XEROX CORPORATION, Norwalk, CT (US)

(21) Appl. No.: 17/356,945

(22) Filed: Jun. 24, 2021

(51) Int. Cl. H04L 12/58

(52) U.S. Cl. CPC H04L 51/22; H04L 51/12; H04L 51/34; H04L 51/26

(57) ABSTRACT

The present disclosure discloses methods and systems for allowing a user to manage one or more email messages to be sent to one or more contacts. The method allows a user to enable a pre-defined SMS (Short Message Services) feature for an email message to be sent to the contacts. The email message is sent to the one or more contacts as composed by a sender. Once sent, it is checked if the response to the email is received by the sender in a pre-defined time and if the response is not received, a pre-defined text message is sent to one of the one or more contacts notifying about the email message. Based on the received text message, the one or more contacts may take an appropriate action.

### TECHNICAL FIELD

The present disclosure relates to the field of emailing, More specifically, the disclosure relates to methods and systems for allowing a user to manage one or more email messages.

### BACKGROUND

In every organization, email platform is one of the important platforms for users to communicate with one or more other users—be it internal users such as team members, employees, manager, or external users such as clients, or consultants. Various examples of the email platforms include MS Outlook, Gmail, Yahoo mail, and so on. MS Outlook is one of the most used email platforms by businesses for sending different types of emails such as advertisement emails, work emails, client interaction, regular update emails, emails related to project queries, and so on. A number of features are available in the email platforms for important or critical emails. For example, to assist the sender in sending such emails, the email platforms include an option to tag such emails as high importance email, so that once a recipient of the email receives or reads the email, knows the importance of the email, responds to it and takes adequate action accordingly.

However sometimes, the recipient may not be available in front of his computing device or is offline and thus is not aware of any such email sent by the sender. This becomes even more important when the email sent by the sender is very critical and needs a response from the recipient. For such critical emails, while the sender expects a very quick response, he has to wait for the recipient's response as the recipient is away, and this may delay or otherwise impact the work.

For instance, an application team managing an application observes an error in the application. In this scenario, the application team has to communicate with an Infra team requesting the team to disable high severity alerts when the application is down. So, one maintenance team member sends an email to the Infra team, however, it may happen that no one from the infra team is available 8uonline. Hence, the maintenance team member is required to either wait till the Infra team comes online and replies to the email or call or SMS the team member. This entire situation can be time consuming and frustrating for the sender.

Thus, there is a need for improvised methods and systems that allow a sender/user to manage one or more emails while sending high importance emails.

### SUMMARY

According to aspects illustrated herein, there is a method for allowing a user to manage one or more email messages to be sent to one or more contacts. The method includes allowing a sender to enable a pre-defined SMS (Short Message Services) feature for an email message to be sent to one or more contacts. The email message is sent to the one or more contacts as composed by the sender. Once sent, it is checked if the response to the email is received by the sender within a pre-defined time. If the response is not received within the pre-defined time, a pre-defined text message is sent to one of the one or more contacts. The pre-defined text message may inform the one of the one or more contacts about the email message. Based on the text message, the one of the one or more contacts may take an appropriate action.

According to further aspects illustrated herein, a system for allowing a user to manage one or more email messages to be sent to one or more contacts is disclosed. The system includes an email client running on a computing device of a sender. The email client includes a user interface including a pre-defined SMS (Short Message Services) feature that allows the sender to track responses of one or more email messages. The user interface allows the sender to compose an email message to be sent to the one or more contacts. The user interface also allows the sender to enable the pre-defined SMS feature for the email message to be sent to the one or more contacts. The system further includes an email server that is communicatively coupled to the email client. The email server sends the email message to the one or more contacts as composed by the sender. The email server further checks if the response to the email message is received from one of the one or more contacts within a pre-defined time. And if the response is not received, the email server sends a pre-defined text message to one of the one or more contacts notifying him about the email message. For example, the pre-defined text message may inform the contacts about the email message. Subsequently, the contacts may take an appropriate action.

According to additional aspects illustrated herein, a non-transitory computer-readable medium including instructions executable by a processing resource is disclosed. The non-transitory readable medium allows a sender to enable a pre-defined SMS feature for an email message to be sent to one or more contacts; send the email message to the one or more contacts as composed by the sender; check whether the response to the email message is received by the sender within a pre-defined time; and if not, send a pre-defined text message to one of the one or more contacts. The text message may inform or notify the one or more contacts about the email message.

According to additional aspects illustrated herein, an email platform for allowing a user to track a response of one or more email messages is disclosed. The email platform includes a user interface integrated with a pre-defined SMS functionality that allows a sender to track one or more responses of one or more email messages. The pre-defined SMS feature is enabled by the sender for an email message that the sender wants to track. The user interface further allows the sender to provide one or more inputs based on which a pre-defined text message is sent to one of one or more contacts. The pre-defined text is sent to one of the one or more contacts if response to the email message is not received within a pre-defined time.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 shows an exemplary environment in which various embodiments of the present disclosure can be practiced.

FIG. 2 is a block diagram of a system including an email client running on a computing device and an email server, in accordance with an embodiment of the present disclosure.

FIGS. 3A-3D are exemplary snapshots illustrating implementation of the present disclosure.

FIG. 4 is an exemplary method flowchart for allowing a sender to manage one or more email messages, in accordance with an embodiment of the present disclosure.

FIG. 5 shows an exemplary implementation of the present disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “email message” refers to any critical or crucial email or otherwise any email message for which a sender is expecting a response or wants to track that email message. Such email message requires immediate response and/or action from any of the recipients. In general, whenever any emergency situation occurs such as when a server is down, or website crashes, or the like, a manager or an administrator is required to inform concerned teams or team members via email so that they can take required action. In such scenarios, the sender expects immediate response and/or acknowledgement from the recipient(s) on the received email. In context of the current disclosure, an email message can be considered as important email message which can be identified as important email message automatically by the multi-function device or any of its components or can be manually identified by the sender. The email message can be identified as important email message based on keywords, based on the content, based on sender, based on a time period, or the like.

The term “email platform” refers to a platform that provides end-to-end emailing solution such as allowing a user to compose an email, sending the email to one or more contacts, receiving a response from the one or more contacts on the sent email, and so on. The email platform includes two components—an email client and an email server that are communicatively coupled to each other.

The term “email client” refers to a front-end application that allows a user to view emails, compose emails, manage emails, or the like. The email client can be installed on a computing device such as laptop, mobile device, personal digital assistant, and other similar devices. Exemplary email clients include Microsoft Outlook, Apple Mail, Mozilla Thunderbird, and the like. In the context of the disclosure, the email client includes a new feature ‘Pre-defined SMS’ that can be enabled by a user for any email message to be sent to one or more contacts.

The term “email server” refers to a back-end computer system that sends and receives emails. For example, the email server receives an email message sent by a sender/user via the email client and then transfers this message to one or more contacts/recipients. The email server may then receive a response message from the one or more contacts and transfers the response message to the sender/user. Exemplary email servers include Microsoft exchange server, IceWrap mail server, hMail server, etc. The email servers send and receive emails using standard email protocols. For example, the SMTP (simple mail transfer protocol) protocol sends messages and handles outgoing email requests. The IMAP (internee message access protocol) and POPS (Post Office Protocol version 3) protocols receive messages and are used to process incoming email. In the context of the present disclosure, the email server continuously tracks if a response to the email message for which the SMS feature is enabled, is received from any of the one or more contacts. The email server automatically sends a pre-defined message to the contacts in case the response is not received within a pre-defined time.

The term “Pre-defined SMS” feature refers to a feature provided to the user via the email client. The user can enable the feature to track response to the email message sent to the one or more contacts. In case the response is not received, the feature includes sending a text message/SMS to the one or more contacts. The pre-defined SMS may be sent to inform or notify the contacts about the email message. Based on the received pre-defined SMS, the contacts may take an appropriate action. In context of the current disclosure, the emails with pre-defined SMS feature selected are automatically tagged as important emails.

The term “pre-defined time” refers to a time interval or time window within which the response to the sent email message is expected to be received from one of the one or more contacts. In context of the current disclosure, if the response is not received from the one or more contacts within the pre-defined time, a text message/SMS is sent to the one or more contacts. The pre-defined time is set by the user or the sender at the time of sending the email message to the one or more contacts. The pre-defined time can be default time as set by the admin user.

The term “computing device” refers to a device that a user typically uses for his day-to-day work such as to send emails, receive emails, view emails and other purposes. Examples of the computing device include, but are not limited to, a personal computer, a desktop, a laptop, a mobile phone, a tablet, a Personal Digital Assistant (PDA), a smart-phone or any other device capable of sending and receiving emails. The computing device includes one or more application. In context of the current disclosure, the computing device includes an email client application that can be accessed by the user to manage one or more email messages to be sent to one or more contacts.

The term “sender” refers to a user who sends an email message to one or more contacts, where the one or more contacts are the recipients of the email message. The sender can be interchangeably used with the phrase “user”.

### Overview

The present disclosure discloses methods and systems for allowing a user/sender to manage one or more email messages. The methods and systems provide a new feature of automatically sending a text message/SMS to one or more recipients of the email message if the recipients do not respond to the email message within a pre-defined time interval. For example, a sender/user may send an important email message to one or more recipients and expects to receive a response on the email message within a time interval, say 10 minutes. In some cases, a recipient may be offline for one or more reasons such as, he is in a meeting and do not have access to email messages, he is on leave without access to his email account, etc. In all these cases, the response is not received from the recipient within the expected time interval. Using the present disclosure, if the response is not received within 10 minutes, a text message/SMS (Short Message Services) is automatically sent to the recipient to let him know that the email message is sent to him and he should take an appropriate action on the sent message.

### Exemplary Environment

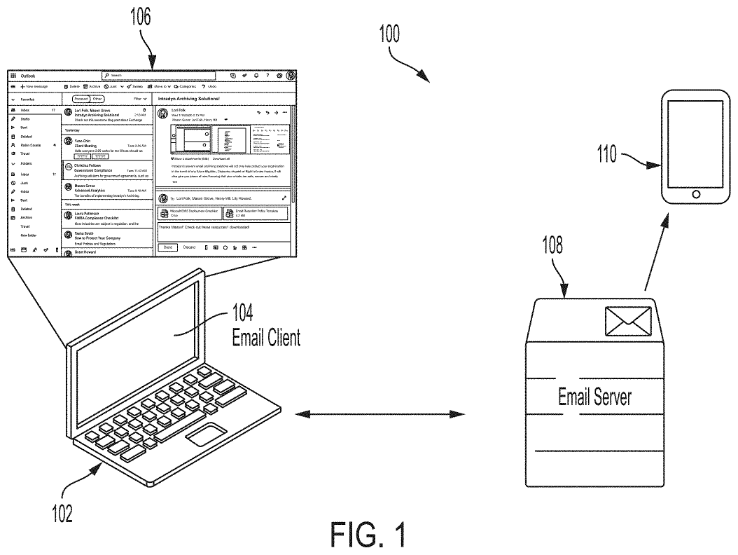

FIG. 1 shows an exemplary environment 100 in which various embodiments of the disclosure can be practiced. The environment 100 includes a computing device 102, an email server 108 and a mobile device 110. The computing device 102 is communicatively coupled to the email server 108 via Internet. A user uses the computing device 102 for his day-to-day tasks such as chatting, surfing, sending/receiving emails, or the like. Various examples of the computing device 102 may be a laptop, a personal computer, a mobile device, a personal digital assistant or any known or later developed computing device. The computing device 102 runs several applications such as an email client 104.

The email client 104 allows a user to view and manage his email messages. The email client 104 provides a user interface 106 to allow the user to configure his email address, receive email messages, read received email messages, compose new email messages, or the like. Exemplary email clients 104 include Mozilla Thunderbird, Microsoft Outlook, Mailbird, Apple Mail, etc. In the context of the disclosure, the email client 104 includes a ‘pre-defined SMS’ feature that allows the user to use the feature if he wishes to track any specific email message or wants urgent attention from any of the recipients or wants to indicate the importance of the email message for the recipients, or so on. The user can enable the SMS feature or disable the SMS feature based on the requirement. Further, the email client 104 and the email server 108 together forms an email platform, where the email platform allows users to perform various tasks related to emails such as composition of an email message, sending the email message to one or more contacts, receiving email messages from email senders, viewing the received email messages, or the like.

In operation, a user wishes to send an important email message to one or more contacts. The email message may be sent to inform the one or more contacts about a situation such as server crash, website crash, etc., so that the contacts may take a required action based on the received email message. To that end, the user first accesses the email client 104 installed on the computing device 102, composes the email message and selects the one or more contacts to whom the email message is to be sent. Thereafter, the user selects the pre-defined SMS feature and sends the email message. Once the user sends the email message, the email server 108 receives the email message and forwards the email message to the one or more contacts via their respective email servers. Further, the email server 108 waits for the response (of the email message) from the one or more contacts for a pre-defined time. If the one or more contacts fail to respond within the pre-defined time, the email server 108 sends a pre-defined text message to the one or more contacts on their respective devices, e.g., a mobile device 110, to inform the recipients about the important email message.

For the sake of clarity one example is discussed now. In this example, an admin user is required to get a server maintenance task completed within 12 hours from a server team. Before the admin user delegates the server maintenance task to the team, the admin user is required to get an approval from his department head. Therefore, the admin user composes an email message using the email client 104. The email message captures necessary details/content about the server maintenance task and urgency of getting the task completed in next 12 hours. Thereafter, the sender selects the pre-defined SMS feature via the user interface 106 of the email client 104. Upon selecting the feature, the user provides details, such as department head's email address, time interval within which a response is expected, etc., and sends the email. Now, if the department head fails to respond to the email message within the specified time interval, the email server 108 automatically sends an SMS to the department head on his mobile device 110 notifying his about the email and its importance. The head of department accesses the SMS via his mobile device 110, sees the email message, and takes the needed action such as approving the email message. Thus, the environment 100 allows the admin user to manage the important email message. Also, the environment 100 notifies the department head about the email message, where the notification is received on his personal device such as a mobile device. Based on the notification, the department head may take an appropriate action on the email message.

### Exemplary System

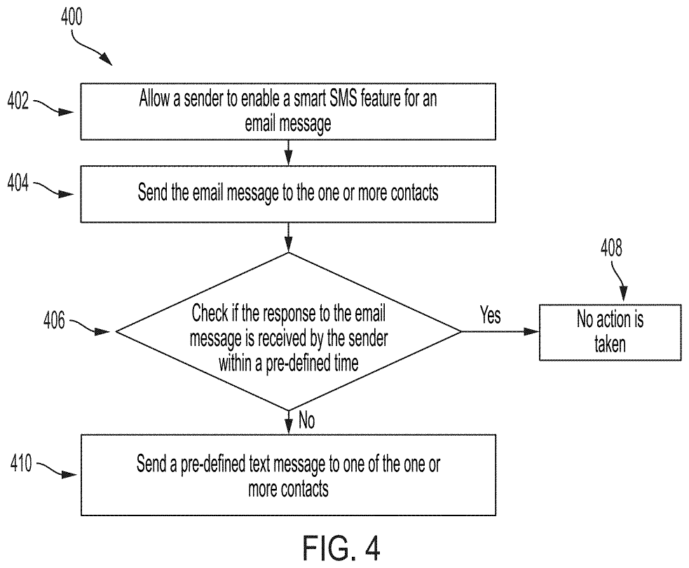

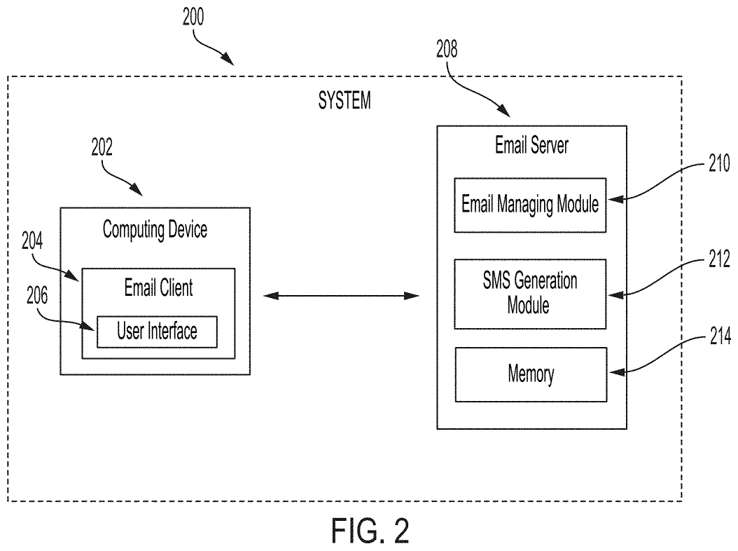

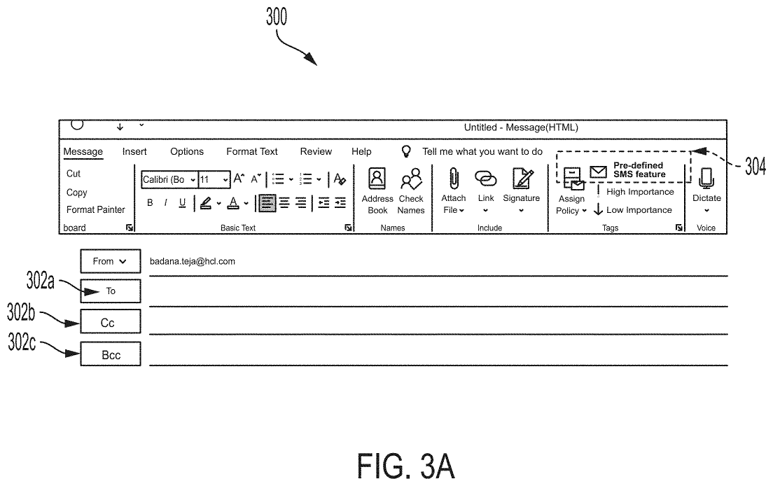

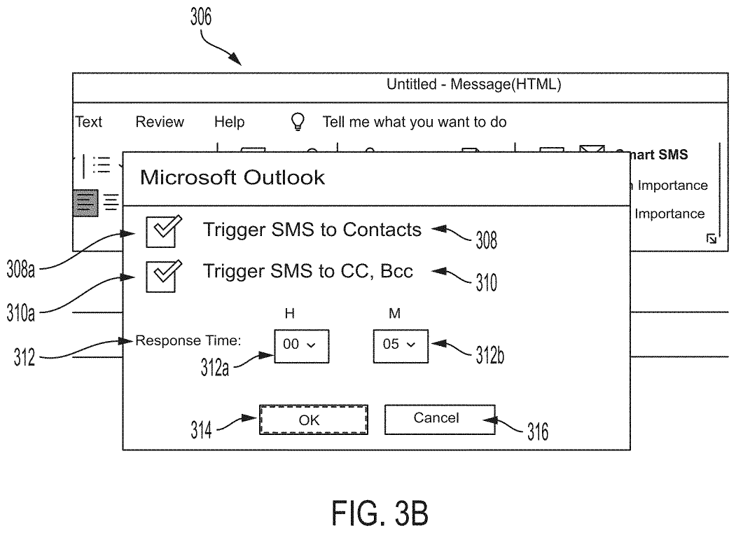

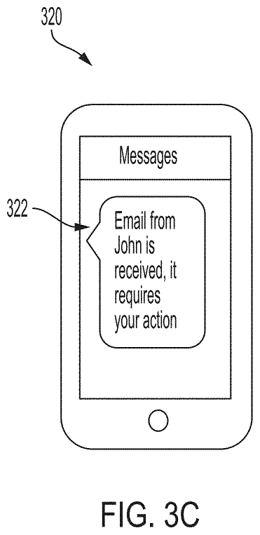

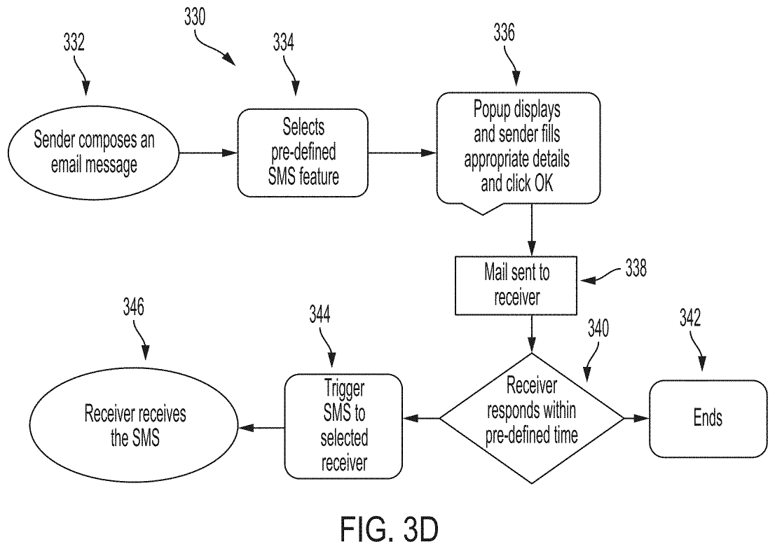

FIG. 2 is a block diagram of a system 200 including a computing device 202 and an email server 208, according to an embodiment of the present disclosure. As shown, the computing device 202 includes an email client 204 that allows a user to manage and view his email messages. The email client 204 provides a user interface 206 that can be accessed by the user to compose new email messages, view received email messages, download content of the email messages, or the like. As will be discussed in detail in FIG. 3A, the user interface 206 includes a ribbon having multiple options allowing the user to take various actions including, but not limited to, composing email messages, sending email messages, recalling email messages, viewing email messages, navigating between multiple folders, updating folders, delete a received email message, marking an email message as important. In the context of the present disclosure, the user interface 206 includes a feature of ‘pre-defined SMS’. The pre-defined SMS feature can be enabled by the user to manage one or more important email messages. The pre-defined SMS feature assists the user in notifying recipients of the important email messages, if the recipients fail to reply or could not otherwise respond to the important email messages within a pre-defined time interval.

Referring back to components of the system 200, the computing device 202 is communicatively coupled to the email server 208 via the Internet to perform various tasks. The email server 208 includes an email managing module 210, an SMS generation module 212, and a memory 214. The email server 208 may further include additional component(s) as required to implement the present disclosure. Also, the email server 208 may perform functions and operations similar to the email server 108 of FIG. 1.

The implementation begins when a user wishes to inform one or more other users about an email message related to a server crash or a website crash, etc., so that the user himself and/or one or more other users can take required actions on the received email message. Thus, the user wishes to send an email message to the one or more other users/contacts and obtain a quick response from the one or more contacts. To that end, the user uses the email client 204 to send the email message to the one or more other users/contacts.

Upon accessing the email client 204, the user interface 206 is displayed to the user. The user interface 206 includes various options and fields for user's selection. Some of the options displayed are—compose a new email message, add one or more contacts/recipients, attach files, and so on. The user selects the option to compose a new email message. The user composes the email message by adding desired content and/or attaching relevant documents/files. Once composed, the user enters email addresses of the contacts/recipients to whom the user wishes to send the email message. The user interface 206 displays various fields such as ‘To’, ‘Cc’, and ‘Bcc’ and the user can add one or more contacts in these fields as per requirement. For instance, in case of a website crash, the user may wish to add all the managers of different teams handling the website in the ‘To’ field and the senior managers and the department heads in the ‘Cc’ field. Once the desired one or more contacts are added/selected by the user, the user selects the pre-defined SMS feature/option to enable the SMS feature. One exemplary user interface 300 showing the pre-defined SMS option is shown in FIG. 3A. As shown, the user interface 300 displays a pre-defined SMS option 304 to allow the user to select and enable the pre-defined SMS feature. The user interface 300 also includes option 302a, 302b, 302c to allow the user to add contacts/recipients in ‘To’, ‘Cc’ and ‘Bcc’ fields, respectively.

Once the user selects the pre-defined SMS option, the user interface 206 allows the user to provide one or more inputs based on which a pre-defined text message is to be sent to the one or more contacts. The one or more inputs can be—content of the pre-defined text message to be sent, selection of contacts to whom the message/SMS is to be sent, desired time window after the expiry of which the SMS is to be sent to the selected contacts, and so on. An exemplary user interface 306 showing the input options is shown in FIG. 3B. As illustrated, the user interface 306 displays options 308 and 310 to allow the user to select the desired recipients/contacts to whom the SMS is to be sent. The options 308 and 310 are provided with checkboxes 308a and 310b, respectively, for selection of desired options. Here, if the user selects the option 308 by checking the check box 308a, the SMS is sent to all the contacts/recipients added in the ‘To’ list and if the user selects the option 310 by checking the check box 310a, the SMS is sent to all the contacts/recipients added in the ‘Cc’ list and the ‘Bcc’ list. The user can select both the options 308 and 310. Here, if the user selects only a single option, say option 308, then the SMS is only sent to the contacts/recipients added in the ‘To’ list. Further, the user interface 306 displays an option 312 that allows the user to add a desired response time/time window after which the SMS is to be sent to the selected contacts. To accomplish this, additional options of adding hours H (marked as 312a) and minutes M (marked as 312b) are provided. The options 312a and 312b are provided as dropdowns and the user can select any desired time window by selecting appropriate dropdowns. Exemplary time window can be 10 minutes, 1 hour, 1 hour and 30 minutes, or the like. The time window can be decided based on the criticality of the email message. For instance, if a server of a bank goes down during working hours of the bank, then the response time/tire window (for receiving response of an email seeking resolution for the situation) can be small, say 10 mins and if the server goes down during off hours of the bank, then the response time/time window can be comparatively bigger, say 2 hours. Once the user selects the desired time window (pre-defined time), he clicks on an option ‘OK’ (marked as 314) to submit his selection/inputs. The user can click on ‘Cancel’ (marked as 316) to dismiss the selection of options at any point.

This way, the user provides his inputs related to the pre-defined SMS option. Once provided, the user sends the important email message to the one or more contacts via the user interface 206. Thereafter, the email client 204 forwards the email message to the email server 208 along with information associated with the email message such as email addresses of the one or more contacts. The email client 204 also sends the one or more inputs associated with the pre-defined SMS option such as pre-defined time after which the SMS is to be sent, contacts to whom the pre-defined SMS is to be sent, the content to be sent in the pre-defined SMS, etc.

Subsequently, the email server 208 receives the email message, associated information, and the one or more inputs related to the pre-defined SMS option. Once received, the email server 208 analyzes the received information associated with the email message and the pre-defined SMS option. In particular, the email managing module 210 first analyzes the information related to pre-defined SMS to identify whether the pre-defined SMS feature is enabled or not, if enabled, then identify the recipients to whom the SMS is to be sent, and the pre-defined time window after expiry of which the SMS is to be sent. Once the email managing module 210 identifies that the pre-defined SMS feature is enabled, the email managing module 210 identifies the one or more contacts selected by the user while configuring the pre-defined SMS feature, i.e., the list of contacts selected for sending the SMS. For instance, the one or more inputs related to the pre-defined text message/SMS may indicate that the SMS is to be sent to the contacts listed in ‘To’ field. As a result, the contacts listed/mentioned in the ‘To’ field are identified. Further, if the one or more inputs indicate that the recipients/contacts listed in ‘To’, ‘Cc’ and ‘Bcc’ field are to be selected for sending the SMS/text message, then all the recipients listed/mentioned in the ‘To’, ‘Cc’ and ‘Bcc’ field are identified. Furthermore, the email managing module 210 obtains the contact details, i.e., phone numbers, of the identified contacts, which may be pre-stored in the memory 214 of the email server 208. In one example, the email server 208 maintains a repository of contact details of all the contacts. In another example, the email server 208 can communicate with the email client 204 to fetch the contact details. Once the one or more contacts to whom the SMS is to be sent are identified, the email managing module 210 identifies the pre-defined time selected by the user for sending the SMS.

Thereafter, the email managing module 210 analyzes the information associated with the email to identify the email addresses of all the recipients of the important email message. Once identified, the email managing module 210 sends the important email message to all the recipients on their respective email address via corresponding email servers. The email managing module 210 sends the email using standard email protocols such as SMTP.

Once the email message is sent, the email managing module 210 monitors the required one or more recipients/contacts have responded to the important email message or not. To accomplish this, the email managing module 210 analyzes one or more emails received by the user who sent the important email message. In one example, the email managing module 210 may check/verify the response by comparing the subject of the sent email message with subject of emails received by the sender. In another example, the managing module 210 may check/verify the response based on analysis of the content of the important email message and the content of the email received, from the one or more contacts, by the user. This way, the email managing module 210 verifies whether the response of the important email message is received from the one or more recipients. For instance, if an email message is received from the one or more contacts recipient, however, the email message does not correspond to the response of the important email message sent by the user/sender, then the email managing module 210 do not consider the email message as the response. In some scenarios, the email message received from one or more recipients is an automatic reply such as ‘Out-Of-Office’ message. Such email messages are not considered as the response to the important email message sent by the user/sender.

The email managing module 210 monitors all the emails received by the sender until the pre-defined time window ends. In a scenario, where no response is received from the one or more contacts, the email managing module 210 triggers the SMS generation module 212 to send the SMS/text message to the one or more contacts identified for sending the SMS. Alternatively, if the response is received from only one of the one or more contacts, then the SMS generation module 212 sends the text message/SMS only to the other contacts whose reply to the important email message is not received within the pre-defined time.

The SMS generation module 212 obtains the contact details of all the contacts identified for sending the SMS. In one scenario, the SMS generation module 212 obtains contact details from the memory 214. Thereafter, the SMS generation module 212 sends the pre-defined text message/SMS to all the recipients identified for sending the SMS. The SMS/pre-defined text message includes a message to inform the recipient about the importance of the email message. In one example, the message can be a pre-defined message such as “please check your e-mail”, “please reply to an urgent email”. In another example, the pre-defined text message can be dynamic message, which includes a subject line of the email message and the name of the sender of the email message. One exemplary SMS received by one of the contacts is shown in a snapshot 320 in FIG. 3C. As shown, the message “Email from John is received, it requires your action” (marked as 322) is received by the contact on his computing device (such as a mobile device).

In the above example, if a response to the important email message is received from the one or more contacts before the expiry of the pre-defined time window, then the SMS is not sent. Also, if the response to the email message is received from only few of the contacts, then the SMS is sent to the remaining contacts.

Continuing with description of FIG. 2, the memory 214 stores all relevant information required for implementing the current disclosure. For example, the memory 214 maintains a repository of contact details, i.e., phone numbers of all the users. Further, the memory 214 temporarily stores the email message and the information related to the email message received from the computing device 202. Any details stored in the memory 214 may be retrieved by the email managing module 210, the SMS generation module 212 or other components for implementing the current disclosure.

While the system 200 discussed a scenario where the user manually tags the email message as important, the system 200 may include capabilities (such as application, algorithm, etc.) to automatically tag an email message as important. Scenarios where the system 200 may automatically tag an email message as important message may be—an email can be automatically tagged as important if the email is to be sent to senior officials of an organization (e.g., CEO, MD, etc.), all e-mails to chief of security, all e-mails with certain keyword in subject line, e-mails that are detected to have been re-sent or undelivered more than n number of times within a time period, an email detected with certain text in the e-mail, some time-sensitivity or other triggers, and so on, can be considered and tagged as important. These are a few examples and the system 200 can tag any email as important based on either system based or user-selected parameters. The system 200 may include any additional modules or components to automatically tag an email message as important without departing from the scope of present disclosure.

### Exemplary Snapshot

FIG. 3D illustrates a method flow diagram 330 for implementing the present disclosure. The method 330 begins when a user (i.e., sender) wishes to send an important email message to one or more contacts (i.e., receiver). Here, the sender also wishes to notify the receiver via an SMS, if the receiver fails to respond to the message within a pre-defined time/desired time window.

In operation, at 332, the sender composes the important email message by adding desired content and attaching one or more required files. Once composed, the sender adds one or more receivers by adding corresponding email addresses of the receivers.

Once added, at 334, the sender selects the pre-defined SMS feature. Once selected, at 336, a pop-up is displayed to the sender. The sender is required to provide appropriate details. The details include one or more inputs related to a text message that is to be shared with the receivers in case the receivers fail to respond to the email message with the pre-defined time. The inputs may include a list of receivers who will receive the text message/SMS, if the receivers fail to respond to the important email message within the pre-defined time. The inputs may further include the pre-defined time window after the expiry of which the text message/SMS is to be sent to the one or more receivers. Once selected, the sender confirms the details by selecting an option, say ‘OK’.

Thereafter, at 338, the email is sent to all the receivers selected by the user/sender.

Once sent, at 340, it is checked whether the receivers selected by the user/sender while configuring the pre-defined SMS inputs responded within the selected time window. If the response is received, the method moves to 342 and no action is taken. However, if the response is not received from the receivers before expiry of the pre-defined time/desired time window, at 344, an SMS/pre-defined text message is sent to the receivers. Once sent, at 346, the receivers are informed about the importance of the email message. Now the receivers can come online and respond to the important email message.

### Exemplary Flowchart

FIG. 4 is a method flowchart 400 for allowing a user to manage one or more email messages, in accordance with an embodiment of the present disclosure. The method 400 may be implemented using the system 200 of FIG. 2. However, the method 400 can be implemented at any equivalent system or device with email receiving and sending functionality.

The method begins when a user wishes to inform one or more other users about an emergency situation, such as a server crash, website crash, etc., so that the user himself and/or one or more other users can take required actions. Thus, the user wishes to send an important email message to one or more contacts/recipients with an expectation to obtain a quick response and/or acknowledgement from the recipients. Therefore, the user composes the email message by adding desired content and/or attaching relevant documents/files. Once composed, the user adds the recipients (such as email addresses of one or more contacts) to whom the user wishes to send the email message. The user can add one or more recipients in different fields such as ‘To’, ‘Cc’, and ‘Bcc’ depending upon the requirement. For instance, in case of a server crash, the user may wish to add a manager of a team handling the server crash in the ‘To’ field and the senior manager and the department head in the ‘Cc’ field.

Once the desired one or more recipients or contacts are entered/selected by the user, at 402, the user enables a pre-defined SMS feature. The pre-defined SMS feature is enabled by the user wither when the email message is important for the user/sender or when the user/sender wants to track the response to the email message Once enabled, the user is prompted to provide details related to the pre-defined SMS feature. The details include list of recipients to whom the SMS is to be sent in case the recipients fail to respond to the email message and the time window after the expiry of which the SMS is to be sent. The user indicates the one or more recipients by selecting one or more fields from the ‘To’, ‘Cc’, and ‘Bcc’ field. Once the user/sender selects the one or more fields, all the recipients listed in the selected field are identified for sending the SMS. In addition, the user provides inputs related to the SMS or pre-defined text message that is to be sent to one or more of the recipients, if the response from one or more recipients is not received within a pre-defined time interval. For example, the user may input the content that is to be included in the text message, and so on. After providing details related to the pre-defined SMS, the user initiates sending of the email, e.g., by selecting an option say ‘send’ option.

At 404, the email message is sent to all the contacts or recipients selected by the user/sender.

Once sent, at 406, it is determined if a response to the email message is received by the sender within a pre-defined time window. For instance, continuous tracking of response to the sent email message from the one of the one or more contacts is done. If the response to the email message is received, the method proceeds to 408 in the conventional ways. If the response is not received within the pre-defined time interval, for any reasons such as the recipient is offline, the method proceeds to 410 and a pre-defined SMS/text message is sent to the one or more contacts/recipients selected by the user/sender. The pre-defined text message is generate based on the inputs provided by the sender. The pre-defined SMS/text message is sent to notify the recipients about the importance of the email message. As a result, the recipients can take an appropriate action such as replying to the email message sent by the user.

In the above method 400, the email message is tagged as important by the user. The user clicks on an ‘important’ tag that may be provided by an email client (such as email client 204 of FIG. 2) via its user interface. Alternatively, the email message can be automatically tagged as important email message based on various factors such as e-mails sent to higher authorities or senior management (e.g., CEO, MD, etc.) can be automatically marked as important. Similarly, all e-mails to chief of security, all e-mails with certain keyword in subject line, e-mails that are detected to have been re-sent or undelivered more than n number of times within a time period, and so on, can be considered and tagged as important automatically. In some instances, an email can be considered as important by detecting certain text in the e-mail, some time-sensitivity or other triggers.

### Exemplary Office Environment

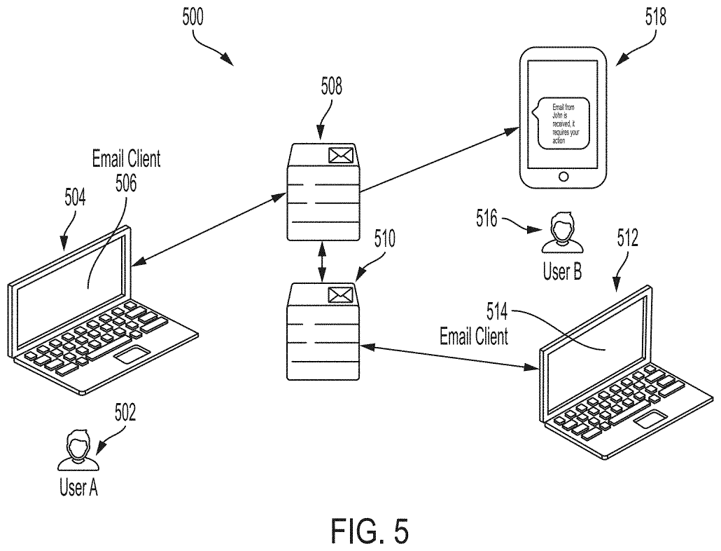

An exemplary use case scenario for implementing the current disclosure is discussed in conjunction with FIG. 5. But it is understood that the disclosure can be implemented for other case scenarios without limiting its scope.

FIG. 5 represents an exemplary environment 500 in which a user A 502 wishes to send an important email message to a user B 516 to inform the user B 516 about a critical situation, e.g., about a website crash handled by a team managed by the user B 516, so that the user B 516 takes a required action. Here, it is considered that the situation is very critical and the user A 502 wishes to obtain the response from the user B 516 at the earliest. Thus, user A 502 accesses an email client 506 installed on his computing device 504 and composes an email message describing about the situation. Once composed, the user A 502 adds the email address of the user B 516 and selects the pre-defined SMS feature. Thereafter, the user A 502 configures the pre-defined SMS related parameters by selecting the ‘To’ filed which include user B and the time window (i.e., pre-defined time) such as 15 mins. Then, the user A 502 sends the email and once sent, an email server 508 associated with the email client 506 receives the email and forwards it to the email address of the user B 516 via email server 510. Once sent, the email server 508 continuously monitors whether the user B 516 responded to the email message. The user B 516 can read the email and reply to it via an email client 514 installed on his computing device 512. However, if the user B 516 fails to respond within the pre-defined time, i.e., 15 mins, the email server 508 sends an SMS/text message on a mobile device 518 of the user B 516. Thus, the user B 516 is notified about the important email sent by the user A 502 even if the user B 516 is offline or not in front of his computing device 512.

The present disclosure discloses methods and systems for allowing a user to manage one or more important email message. The methods and systems propose a pre-defined SMS feature that assist in notifying one or more recipients of an email message, if the one or more recipients do not reply/respond to the email message within a pre-defined time window. As a result, the methods and systems ensure that the one or more recipients are informed about the important email message even if the recipients are offline. Thus, the methods and systems offer a failsafe solution and assist is reducing/avoiding work-related communication delays.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as sending, receiving, checking, emailing, generating, tracking, or the like refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMS), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for allowing a user to manage one or more email messages to be sent to one or more contacts, the method comprising:
allowing a sender to enable a pre-defined SMS feature for an email message to be sent to one or more contacts;
sending the email message to the one or more contacts as composed by the sender;
checking whether the response to the email message is received by the sender within a pre-defined time; and
if not, sending a pre-defined text message to one of the one or more contacts.

2. The method of claim 1, wherein the pre-defined text message is sent to one of the one or more contacts included in at least one of, “To list”, “CC list”, and “BCC list”.

3. The method of claim 1, further comprising, checking whether the response of the email is received, based on an identifier associated with the email message.

4. The method of claim 1, further comprising, allowing the sender to provide one or more inputs related to the pre-defined text message, before sending the email message to the one or more contacts.

5. The method of claim 1, further comprising, generating the pre-defined text message to be sent to the one of the one or more contacts, based on one or more inputs provided by the sender.

6. The method of claim 1, wherein one of the one or more contacts is an offline contact.

7. The method of claim 1, further comprising, continuously tracking the response of the email message from the one of the one or more contacts after a pre-defined time interval.

8. The method of claim 1, wherein the pre-defined SMS feature is enabled for the email message where the sender wants to track the response to the email message.

9. The method of claim 1, wherein the pre-defined SMS feature is enabled by the user at least: when the email message is important for the sender or when the sender wants to track the response to the email message.

10. A system for allowing a user to manage one or more email messages to be sent to one or more contacts, the system comprising:
an email client running on a computing device of a sender, the email client comprising:
a user interface comprising a pre-defined SMS (Short Message Services) feature allowing the sender to track responses of one or more email messages, wherein the user interface is for:
allowing the sender to compose an email message to be sent to the one or more contacts; and
allowing the sender to enable the pre-defined SMS feature for the email message to be sent to the one or more contacts; and
an email server communicatively coupled to the email client, for:
sending the email message to the one or more contacts as composed by the sender;
checking whether the response to the email message is received from one of the one or more contacts within a pre-defined time; and
if not, sending a pre-defined text message to one of the one or more contacts notifying about the email message.

11. The system of claim 10, wherein the pre-defined text message is sent to one of the one or more contacts included in at least one of: “To list”, “CC list”, and “BCC list” of the email message.

12. The system of claim 10, wherein the email server is for checking whether the response of the email is received, based on at least one of: a subject of the email message; the one or more contacts, and content of the email message.

13. The system of claim 10, wherein the user interface is for allowing the sender to provide one or more inputs related to the pre-defined text message to be sent to the one or more contacts.

14. The system of claim 10, wherein the email server is for generating the pre-defined text message to be sent to the one of the one or more contacts, based on one or more inputs provided by the sender.

15. The system of claim 10, wherein the email server is for continuously tracking the response of the email message at a pre-defined regular interval.

16. The system of claim 10, wherein the email server is for checking whether the response of the email message is received from one of the one or more contacts based on an identifier associated with the email message.

17. The system of claim 10, wherein the pre-defined text message is sent when one of the one or more contacts is an offline contact.

18. The system of claim 10, wherein the pre-defined SMS feature is enabled for the email message where the sender wants to track the response to the email message.

19. A non-transitory computer-readable medium comprising instructions executable by a processing resource to:
allow a sender to enable a pre-defined SMS feature for an email message to be sent to one or more contacts;
send the email message to the one or more contacts as composed by the sender;
check whether the response to the email message is received by the sender within a pre-defined time; and
if not, send a pre-defined text message to one of the one or more contacts notifying about the email message.

20. The non-transitory computer-readable medium of claim 19, further comprising instructions executable by a processing resource to generate the pre-defined text message to be sent to the one of the one or more contacts, based on one or more inputs provided by the sender.

21. The non-transitory computer-readable medium of claim 19, wherein the pre-defined SMS feature is enabled when the sender wants to track the response of the email message.

22. An email platform for allowing a user to track a response of one or more email messages, the email platform comprising:
a user interface integrated with a pre-defined SMS functionality that allows a sender to track one or more responses of one or more email messages, wherein the pre-defined SMS feature is enabled by the sender for an email message, the user interface further allows the sender to provide one or more inputs based on which a pre-defined text message is sent to one of one or more contacts, wherein the pre-defined text is sent to one of the one or more contacts if response to the email message is not received within a pre-defined time.
